(19) United States
(12) Patent Application Publication
(10) Pub. No.: US 2025/0218382 A1
(43) Pub. Date: Jul. 3, 2025

(54) PIXEL CIRCUIT AND DISPLAY DEVICE INCLUDING THE SAME

(71) Applicant: LG Display Co., Ltd., Seoul (KR)

(72) Inventors: Jong Min PARK, Paju-si (KR); Dong Won PARK, Paju-si (KR)

(73) Assignee: LG Display Co., Ltd., Seoul (KR)

(21) Appl. No.: 18/948,303

(22) Filed: Nov. 14, 2024

(30) Foreign Application Priority Data
Dec. 27, 2023 (KR) 10-2023-0192176

(51) Int. Cl. G09G 3/3258; G09G 3/00

(52) U.S. Cl. CPC G09G 3/3258; G09G 3/035; G09G 2300/0814; G09G 2300/0819; G09G 2300/0842; G09G 2310/0286; G09G 2310/06; G09G 2320/0242; G09G 2320/0673; G09G 2330/023

(57) ABSTRACT

A pixel circuit includes: a compensation circuit connected to a data line, a first gate line, and a second gate line, and configured to receive first and second voltages alternately through the data line, a first gate signal through the first gate line, and a second gate signal through the second gate line; a light-emitting element; a driving element including a gate electrode configured to receive the second voltage via the compensation circuit, the driving element being configured to generate a current to drive the light-emitting element; and a switch element including a gate electrode configured to receive the second gate signal via the compensation circuit, and configured to switch a path of the current between the driving element and the light-emitting element. The light-emitting element, the driving element, and the switch element may be connected in series between a first power line and a second power line.

### CROSS-REFERENCE TO RELATED APPLICATION

This application claims priority to and the benefit of Korean Patent Application No. 10-2023-0192176, filed on Dec. 27, 2023, the disclosure of which is incorporated herein by reference in its entirety.

### BACKGROUND

### Field

The present disclosure relates to a pixel circuit and a display device including the same.

### Description of Related Art

Electroluminescent display devices are roughly classified into inorganic light-emitting display devices and organic light-emitting display devices based on the material of the emission layer. An active matrix type organic light-emitting display device includes an organic light emitting diode (hereinafter referred to as “OLED”) which emits light by itself and has the advantages of fast response speed and large luminous efficiency, luminance, and viewing angle. In the organic light-emitting display device, the OLED is formed on each of the pixels. The organic light-emitting display device has a fast response speed and excellent luminous efficiency, luminance, and viewing angle, and has an excellent contrast ratio and color reproducibility as it can express black grayscales in full black.

In recent years, thanks to advances in technology that can be flexibly bent or folded using flexible displays, display devices are approaching the implementation of next generation displays, such as rollable displays, foldable displays, bendable displays, slidable displays, and stretchable displays. Such flexible display devices may be applicable not only to mobile devices, such as smartphones and tablet PCs, but also to televisions (TVs), vehicles, wearable devices, and the like, and its application fields are expanding.

A stretchable display device may increase or decrease in the screen size, and may be freely modified in a variety of shapes. To improve the performance of the stretchable display, a pixel circuit that operates stably even when a display panel is deformed and the display panel having a high elongation are required.

### SUMMARY

Accordingly, the present disclosure is directed to a pixel circuit and a display device including the same that substantially obviate one or more of the problems due to limitations and disadvantages of the related art.

The present disclosure provides a highly reliable pixel circuit applicable to a stretchable display device, and a display device including the pixel circuit.

The objects of the present disclosure are not limited to the above-described objects, and other objects not mentioned can be clearly understood by those skilled in the art from the following description.

To achieve these objects and other advantages of the present disclosure, as embodied and broadly described herein, a pixel circuit may include: a compensation circuit connected to a data line, a first gate line, and a second gate line, the compensation circuit being configured to receive first and second voltages alternately through the data line, a first gate signal through the first gate line, and a second gate signal through the second gate line; a light-emitting element; a driving element including a gate electrode configured to receive the second voltage via the compensation circuit, the driving element being configured to generate a current to drive the light-emitting element based on the second voltage; and a switch element including a gate electrode configured to receive the second gate signal via the compensation circuit, the switch element being configured to switch a path of the current between the driving element and the light-emitting element based on the second gate signal. The light-emitting element, the driving element, and the switch element may be connected in series between a first power line and a second power line.

In some example embodiments, the compensation circuit may include: a capacitor coupled between a first node and a second node; a first switch element connected between the data line and the first node and configured to turn on in response to a gate-on voltage of the first gate signal to electrically connect the data line to the first node; a second switch element connected between the second node and a third node and configured to turn on in response to the gate-on voltage of the first gate signal to electrically connect the second node to the third node; a third switch element connected to the first node and configured to turn on in response to a gate-on voltage of the second gate signal to apply the first voltage to the first node; and a fifth switch element connected to a fourth node and configured to turn on in response to the gate-on voltage of the first gate signal to apply the first voltage to the fourth node. The switch element may include a fourth switch element connected between the third node and the fourth node and configured to turn on in response to the gate-on voltage of the second gate signal to electrically connect the third node to the fourth node. the driving element may include a gate electrode connected to the second node, a first electrode connected to the first power line configured to receive a pixel driving voltage, and a second electrode connected to the third node. The light-emitting element may include an anode electrode connected to the fourth node, and a cathode electrode connected to the second power line configured to receive a cathode voltage. The first voltage may be a reference voltage or the cathode voltage, and the second voltage is a data voltage of pixel data. The data line may be configured to receive the data voltage of pixel data after receiving the reference voltage or the cathode voltage.

In some example embodiments, during one horizontal period, the first node may be configured to receive the reference voltage simultaneously via the data line and the first switch element as via the third switch element.

In some example embodiments, the second node, the third node, and the fourth node are configured to receive the reference voltage when the reference voltage is applied to the first node.

In some example embodiments, a driving period of the pixel circuit may include a first phase in which the pixel circuit is configured to be initialized, a second phase in which the capacitor is configured to receive a threshold voltage of the driving element and the data voltage, and a third phase in which the light-emitting element is configured to emit light. The first gate signal may be configured to be at the gate-on voltage in the first phase and the second phase, and at the gate-off voltage in the third phase. The second gate signal may be configured to be at the gate-off voltage in the second phase, and at the gate-on voltage in the first and third phases. The first, second, and fifth switch elements are configured to turn on in response to the gate-on voltage of the first gate signal and to turn off in response to the gate-off voltage of the first gate signal. The third and fourth switch elements may be configured to turn on in response to the gate-on voltage of the second gate signal and to turn off in response to the gate-off voltage of the second gate signal. The one horizontal period may include periods of the first phase and the second phase. The data line may be configured to be at the reference voltage in the first phase and at the data voltage in the second phase.

In some example embodiments, the first switch element may include a gate electrode configured to receive the first gate signal, a first electrode connected to the data line, and a second electrode connected to the first node. The second switch element may include a gate electrode configured to receive the first gate signal, a first electrode connected to the second node, and a second electrode connected to the third node. The third switch element may include a gate electrode configured to receive the second gate signal, a first electrode connected to the first node, and a second electrode configured to receive the reference voltage. The fourth switch element may include a gate electrode configured to receive the second gate signal, a first electrode connected to the third node, and a second electrode connected to the fourth node. The fifth switch element includes a gate electrode configured to receive the first gate signal, a first electrode configured to receive the reference voltage, and a second electrode connected to the fourth node.

In some example embodiments, during one horizontal period, the first node may be configured to receive the cathode voltage simultaneously via the data line and the first switch element as via the third switch element.

In some example embodiments, the second node, the third node, and the fourth node may be configured to receive the cathode voltage when the cathode voltage is applied to the first node.

In some example embodiments, a driving period of the pixel circuit may include a first phase in which the pixel circuit is configured to be initialized, a second phase in which the capacitor is configured to receive a threshold voltage of the driving element and the data voltage, and a third phase in which the light-emitting element is configured to emit light. The first gate signal may be configured to be at the gate-on voltage in the first phase and the second phase, and at the gate-off voltage in the third phase. The second gate signal may be configured to be at the gate-off voltage in the second phase, and at the gate-on voltage in the first and third phases. The first, second, and fifth switch elements may be configured to turn on in response to the gate-on voltage of the first gate signal and to turn off in response to the gate-off voltage of the first gate signal. The third and fourth switch elements may be configured to turn on in response to the gate-on voltage of the second gate signal and to turn off in response to the gate-off voltage of the second gate signal. The one horizontal period may include periods of the first phase and the second phase. The data line may be configured to be at the cathode voltage in the first phase and at the data voltage in the second phase.

In some example embodiments, the first switch element may include a gate electrode configured to receive the first gate signal, a first electrode connected to the data line, and a second electrode connected to the first node. The second switch element may include a gate electrode configured to receive the first gate signal, a first electrode connected to the second node, and a second electrode connected to the third node. The third switch element may include a gate electrode configured to receive the second gate signal, a first electrode connected to the first node, and a second electrode configured to receive the cathode voltage. The fourth switch element may include a gate electrode configured to receive the second gate signal, a first electrode connected to the third node, and a second electrode connected to the fourth node. The fifth switch element may include a gate electrode configured to receive the first gate signal, a first electrode configured to receive the cathode voltage, and a second electrode connected to the fourth node.

In some example embodiments, the first voltage may be a constant voltage, the first voltage being a reference voltage or a cathode voltage. The second voltage may be a data voltage corresponding to a pixel data. During one horizontal period, the compensation circuit may be further configured to receive the first voltage through the data line and then to receive the second voltage through the data line.

In some example embodiments, the one horizontal period may include a horizontal blank period and a horizontal active period. During the horizontal blank period, the compensation circuit may be further configured to receive the first voltage, and not the second voltage, through the data line to initialize the pixel circuit. During the horizontal active period, the compensation circuit may be further configured to receive the second voltage through the data line to write the pixel data to the pixel circuit.

In some example embodiments, the one horizontal period may include a horizontal blank period and a horizontal active period. During the horizontal blank period, the first gate signal and the second gate signal may be at a gate-on voltage. During the horizontal active period, the first gate signal may be at the gate-on voltage, and the second gate signal may be at a gate-off voltage.

In another aspect of the present disclosure, a display device may include: a display panel including a plurality of data lines, a plurality of gate lines, a plurality of power lines, and a plurality of pixel circuits, at least one of the pixel circuits being the pixel circuit described above; a data driver configured to output the first and second voltages; a gate driver configured to supply at least one gate signal to the gate lines; and a control circuit configured to control the data driver and the gate driver. The plurality of data lines may include the data line described above, the plurality of gate lines may include the first gate line and the second gate line described above, the at least one gate signal may include the first gate signal and the second gate signal described above, and the plurality of power lines may include the first power line and the second power line described above.

In some example embodiments, the control circuit may be configured to transmit initialization data to the data driver as a digital signal. The data driver may be configured to output the first voltage in response to the initialization data.

In some example embodiments, the control circuit may be configured to update the initialization data every horizontal period. The first voltage may have a voltage level corresponding to the initialization data.

In some example embodiments, the display panel may include: a plurality of circuit parts in which the pixel circuits are disposed; and a plurality of stretchable wires electrically connecting the plurality of circuit parts. The stretchable wires may include the data lines, the gate lines, and the power lines.

In some example embodiments, the display device may further include a switch circuit configured to alternately select one of the first voltage and the second voltage and to supply the selected one of the first voltage and the second voltage to the data lines.

In some example embodiments, the switch circuit may be further configured to select and supply the first voltage to the data line and then to select and supply to second voltage to the data line within one horizontal period.

The pixel circuit according example embodiments of the present disclosure may be capable of driving the light-emitting element stably without short-circuiting the data voltage and the initialization voltage when it is initialized without being affected by the deviation of the threshold voltage of the driving element and the voltage drop of the power source. In addition, the pixel circuit according example embodiments of the present disclosure may perform the initialization, threshold voltage sampling, and light emission with relatively few gate signals, thereby reducing the number of wires in the display panel.

Accordingly, example embodiments of the present disclosure may implement a highly reliable pixel circuit. The elongation of the stretchable display device may be improved by reducing the number of wires adversely affecting the elongation in the stretchable display device.

The advantages and effects according to the present disclosure are not limited to those described above, and additional advantages and effects are included in or may be obtained from the present disclosure.

Additional features and aspects of the disclosure will be set forth in the description that follows and in part will become apparent from the description or may be learned by practice of the inventive concepts provided herein. Other features and aspects of the inventive concepts may be realized and attained by the structure particularly pointed out in, or derivable from, the written description, claims hereof, and the appended drawings.

It is to be understood that both the foregoing general description and the following detailed description of the present disclosure are by way of example and are intended to provide further explanation of the disclosures as claimed.

### BRIEF DESCRIPTION OF THE DRAWINGS

The accompanying drawings, which are included to provide a further understanding of the disclosure and are incorporated in and constitute a part of this application, illustrate example embodiments of the disclosure and together with the description serve to explain the principles of the disclosure. In the drawings:

FIG. 1 is a circuit diagram schematically illustrating a pixel circuit according to an example embodiment of the present disclosure;

FIG. 2 is a circuit diagram illustrating a pixel circuit according to an example embodiment of the present disclosure;

FIGS. 3A and 3B are diagrams showing example methods of driving a pixel circuit;

FIGS. 4A to 4D are diagrams illustrating example methods of driving a pixel circuit in stages;

FIG. 5 is a circuit diagram illustrating a pixel circuit according to another example embodiment of the present disclosure;

FIGS. 6A and 6B are waveform diagrams illustrating example methods of driving a pixel circuit;

FIG. 7 is a waveform diagram illustrating an output voltage from a data driver according to an example embodiment of the present disclosure;

FIGS. 8A and 8B are diagrams illustrating an example switch circuit connected to a data line;

FIG. 9 is a block diagram illustrating a display device according to an example embodiment of the present disclosure;

FIGS. 10A and 10B are diagrams illustrating other examples of a display device;

FIG. 11 is a diagram illustrating an example of circuit parts and stretch wires of a stretchable display device;

FIG. 12 is a diagram illustrating one frame period and one horizontal period according to an example embodiment of the present disclosure;

FIG. 13 is a diagram illustrating an example transmission line connection structure between a timing controller and source drive ICs on an EPI interface;

FIG. 14 is a waveform diagram illustrating an example of a multi-phase internal clock generated by source drive ICs;

FIG. 15 is a waveform diagram illustrating an example of a signal transfer protocol for an EPI interface;

FIG. 16 is a diagram illustrating an example of one (1) data packet in an EPI interface; and

FIG. 17 is a diagram illustrating an example of a signal transmitted during a horizontal blank period.

### DETAILED DESCRIPTION

Advantages and features of the present disclosure and methods of achieving them will become apparent with reference to the example embodiments described below in detail in conjunction with the accompanying drawings. The present disclosure may, however, be embodied in different forms and should not be construed as limited to the example embodiments set forth herein. Rather, these example embodiments are provided so that this disclosure will be thorough and complete and will fully convey the scope of the present disclosure to those skilled in the art.

The shapes, dimensions, areas, lengths, thicknesses, ratios, angles, numbers, and the like, which are illustrated in the drawings to describe various example embodiments of the present disclosure, are merely given by way of example. Therefore, the present disclosure is not limited to such illustrated details in the drawings. Like reference numerals generally denote like elements throughout the specification, unless otherwise specified.

In the following description, where a detailed description of a relevant known function or configuration may unnecessarily obscure aspects of the present disclosure, a detailed description of such a known function or configuration may be omitted or be briefly discussed.

Where a term like “comprise,” “have,” “include,” or “composed of” is used, one or more other elements may be added unless the term is used with a more limiting term, such as “only.” An element described in a singular form may include a plurality of elements, and vice versa, unless the context clearly indicates otherwise.

In construing an element, the element should be construed as including an ordinary error or tolerance range even where no explicit description of such an error or tolerance range is provided.

Where a positional relationship between two elements is described with such a term as “on,” “above,” “below,” “next to,” “connected with,” “coupled with,” “crossing,” “intersecting,” or the like, one or more other elements may be located between the two elements unless the term is used with a more limiting term, such as “immediate (ly)” or “direct (ly).”

Where a temporal relationship is described using such a term as “after,” “following,” “next to,” “before,” or the like, it may include a non-consecutive case unless it is used with a more limiting term like “immediately” or “directly.”

Although terms “first,” “second,” and the like may be used herein to describe various elements, these elements should not be interpreted to be limited by these terms as they are not used to define a particular essence, order, sequence, precedence, or number of such elements. These terms are used only to refer one element separately from another. For example, a first element could be termed a second element, and a second element could similarly be termed a first element, without departing from the scope of the present disclosure.

Features of various embodiments of the present disclosure may be partially or wholly coupled to or combined with each other, and may be operated, linked, or driven together in various ways as those skilled in the art can sufficiently understand. The embodiments of the present disclosure may be carried out independently from each other, or may be carried out together in association with each other.

A pixel circuit and a gate drive circuit of a display device may include a plurality of transistors. The transistors may be implemented as thin film transistors (TFTs). The transistors may be implemented as an oxide thin film transistor (TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is lower than a drain voltage such that electrons may flow from a source to a drain. The n-channel transistor has a direction of a current flowing from the drain to the source. In the case of a p-channel transistor (p-channel metal-oxide semiconductor (PMOS)), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the present disclosure is not limited to a specific designation of a source and a drain of a transistor. In the following description, a source and a drain of a transistor may be interchangeably referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

The pixel circuit according to one or more example embodiments of the present disclosure may be initialized to an initialization voltage. The initialization voltage may be either the reference voltage or the cathode voltage.

Hereinafter, various example embodiments of the present disclosure will be described in detail with reference to the accompanying drawings.

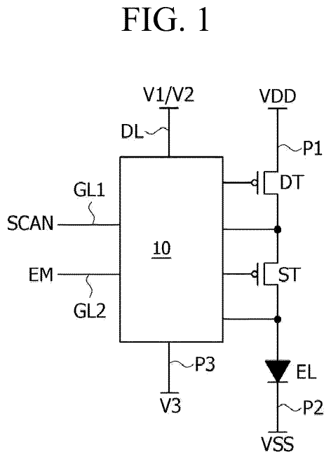

FIG. 1 is a circuit diagram schematically illustrating a pixel circuit according to an embodiment of the present disclosure.

As shown in FIG. 1, a pixel circuit may include a light-emitting element EL, a driving element DT, a switch element ST, and a compensation circuit 10. The switch element ST and the driving element DT may be implemented as p-channel transistors but are not limited thereto.

The light-emitting element EL may be, but is not limited to, a light-emitting element such as an OLED or a micro LED. The light-emitting element EL may include an anode electrode, a light emitting layer, and a cathode electrode. The light-emitting element EL, the driving element DT, and the switch element ST may be connected in series between a VDD node P1 to which a pixel driving voltage VDD is applied, and a VSS node P2 to which a cathode voltage VSS is applied. The VDD node P1 may be connected to a first power line that is connected in common to some or all of the pixels on a display panel. The VSS node P2 may be connected to a second power line that is connected in common to some of all of the pixels on the display panel.

The driving element DT may drive the light-emitting element EL by generating a current for driving the light-emitting element EL according to a gate-source voltage.

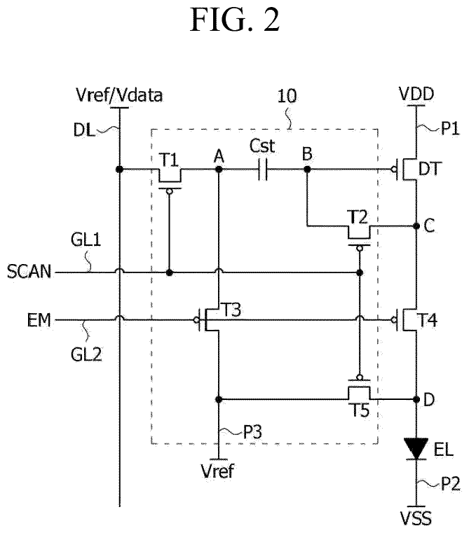

The switch element ST may switch the current path between the pixel drive voltage VDD and the cathode voltage VSS in response to a second gate signal EM to regulate the emission time of the light-emitting element EL. The switch element ST may be, for example, a fourth switch element T4 illustrated in FIGS. 2 to 8.

The compensation circuit 10 may be connected to a data line DL to which a first voltage V1 and a second voltage V2 are alternately applied, a first gate line GL1 to which a first gate signal SCAN is applied, and a second gate line GL2 to which a second gate signal EM is applied. The first voltage V1 may be, for example, a reference voltage Vref as shown in FIGS. 2 to 8A, which may be a constant voltage. The reference voltage Vref may be interpreted as the initialization voltage. The second voltage V2 may be, for example, a data voltage Vdata of the pixel data shown in FIGS. 2 to 8B. The compensation circuit 10 may be connected to a constant voltage node P3 to which a third voltage V3 is applied. The constant voltage node P3 may be connected to a third power line that is connected in common to some or all of the pixels on the display panel. The third voltage V3 may be a constant voltage, for example, the reference voltage Vref or the cathode voltage VSS as shown in FIGS. 2 to 8B.

The compensation circuit 10 may include a plurality of switch elements and capacitors. The compensation circuit 10 may receive the data voltage Vdata of the pixel data, the first gate signal SCAN, and the second gate signal EM, and may apply the data voltage Vdata to the gate electrode of the driving element DT. Further, the compensation circuit 10 may control the switch element ST by applying the second gate signal EM to the gate electrode of the switch element ST.

FIG. 2 is a circuit diagram illustrating a pixel circuit according to an example embodiment of the present disclosure.

As illustrated in FIG. 2, the pixel circuit according to an example embodiment of the present disclosure may include a light-emitting element EL, a compensation circuit 10, a fourth switch element T4, a driving element DT, and a capacitor Cst. The compensation circuit may include a plurality of switch elements T1, T2, T3, T5, and a capacitor Cst. The switch elements T1 to T5 and the driving element DT may, but are not limited to, be implemented as a p-channel transistor.

The pixel circuit may be supplied with a data voltage Vdata and gate signals SCAN and EM. The gate signals SCAN and EM may include pulses that swing between a gate-on voltage VGL and a gate-off voltage VGH. A first, second, and fifth switch elements T1, T2, and T5 may turn on/off in response to the voltage of the first gate signal SCAN. A third and fourth switch elements T3 and T4 may turn on/off in response to the voltage of the second gate signal EM.

A constant voltage (or a direct current (DC) voltage), such as a pixel driving voltage VDD, a cathode voltage VSS, a reference voltage Vref, or the like, may be applied to the pixel circuit. The reference voltage Vref may be interpreted as the initialization voltage. The constant voltages applied to the pixel circuit may be set to VDD>Vref>VSS, but the present disclosure is not limited thereto. The gate-off voltage VGH may be set to a voltage that is lower than the pixel drive voltage VDD and lower than the maximum voltage of the data voltage Vdata, but is not limited to. The gate-on voltage VGL may be set to a voltage that is lower than the minimum voltage of the cathode voltage VSS and the data voltage Vdata, but is not limited thereto. The data voltage Vdata has a dynamic range (DR) between a voltage equal to or higher than the cathode voltage VSS and a voltage lower than the pixel drive voltage VDD. The reference voltage Vref may be set to a specific voltage within a range of the data voltage. For example, a voltage applied to the pixel circuit may be set as, but not limited to, VDD=12V, VSS=0V, Vref=2V, VGH=10V, VGL=−10V, Vdata=0V to 9V, and the like.

The light-emitting element EL may be implemented as a light-emitting element, such as an OLED, an inorganic LED such as micro-LED, or the like. The OLED may include an organic compound layer formed between an anode electrode and a cathode electrode. The organic compound layer may include, but is not limited to, a hole injection layer (HIL), a hole transport layer (HTL), a light emitting layer (EML), an electron transport layer (ETL), and an electron injection layer (EIL). The anode electrode of the light-emitting element EL may be connected to a fourth node D. The cathode electrode of the OLED may be connected to a VSS node (or a second power node) P2 to which the cathode voltage VSS is applied. The micro-LED may have, but is not limited to, a vertical structure in which electrodes are arranged above and below a semiconductor chip in which the light-emitting element EL is integrated. The semiconductor chip in which the light-emitting element EL is integrated may be implemented, for example, in a lateral structure or a flip chip structure.

The driving element DT may drive the light-emitting element EL by supplying a current generated according to the gate-source voltage Vgs to the light-emitting element EL. The driving element DT may include a gate electrode connected to a second node B, a first electrode connected to the VDD node P1 to which the pixel driving voltage VDD is applied, and a second electrode connected to a third node C.

The capacitor Cst may be connected between a first node A and the second node B. The first node A may be connected to a second electrode of the first switch element T1, a first electrode of the third switch element T3, and a first electrode of the capacitor Cst. The second node B may be connected to a second electrode of the capacitor Cst, a gate electrode of the driving element DT, and a first electrode of the second switch element T2. The capacitor Cst may be charged with a data voltage Vdata compensated by the amount of a threshold voltage Vth of the driving element DT. Since the data voltage Vdata at each of the sub-pixels may be compensated by the threshold voltage Vth of the driving element DT, characteristic deviations of the driving element in each of the sub-pixels may be compensated to be driven with uniform driving characteristics.

The switch elements T1 to T5 may turn on according to the gate-on voltage VGL applied to their gate electrodes and may turn off according to the gate-off voltage VGH.

A first switch element T1 may turn on in response to the gate-on voltage VGL of the first gate signal SCAN. When the first switch element T1 is turned on, the data voltage Vdata may be applied to the first node A. The first switch element T1 may include a gate electrode connected to a first gate line GL1 to which the first gate signal SCAN is applied, a first electrode connected to the data line DL, and a second electrode connected to the first node A. The first gate signal SCAN may be generated as a pulse of the gate-on voltage VGL. A pulse width of the first gate signal SCAN may be set to approximately one horizontal period (1H).

A second switch element T2 may turn on in response to the gate-on voltage VGL of the first gate signal SCAN. When the second switch element T2 is turned on, the second node B and the third node C may be electrically connected, so that the driving element DT is driven as a diode. The second switch element T2 may include a gate electrode connected to the first gate line GL1, a first electrode connected to the second node B, and a second electrode connected to the third node C.

A third switch element T3 may turn on in response to the gate-on voltage VGL of the second gate signal EM. When the third switch element T3 is turned on, the reference voltage Vref may be applied to the first node A. The third switch element T3 may include a gate electrode connected to a second gate line GL2 to which the second gate signal EM is applied, a first electrode connected to the first node A, and a second electrode connected to a Vref node P3.

A fourth switch element T4 may turn on in response to the gate-on voltage VGL of the second gate signal EM. When the fourth switch element T4 is turned on, the third node C may be electrically connected to the fourth node D. The fourth switch element T4 may include a gate electrode connected to the second gate line GL2, a first electrode connected to the third node C, and a second electrode connected to the fourth node D.

A fifth switch element T5 may turn on in response to the gate-on voltage VGL of the first gate signal SCAN. When the fifth switch element T5 is turned on, the reference voltage Vref may be supplied to the fourth node D. The fifth switch element T5 may include a gate electrode connected to the first gate line GL1, a first electrode connected to the Vref node P3, and a second electrode connected to the fourth node D.

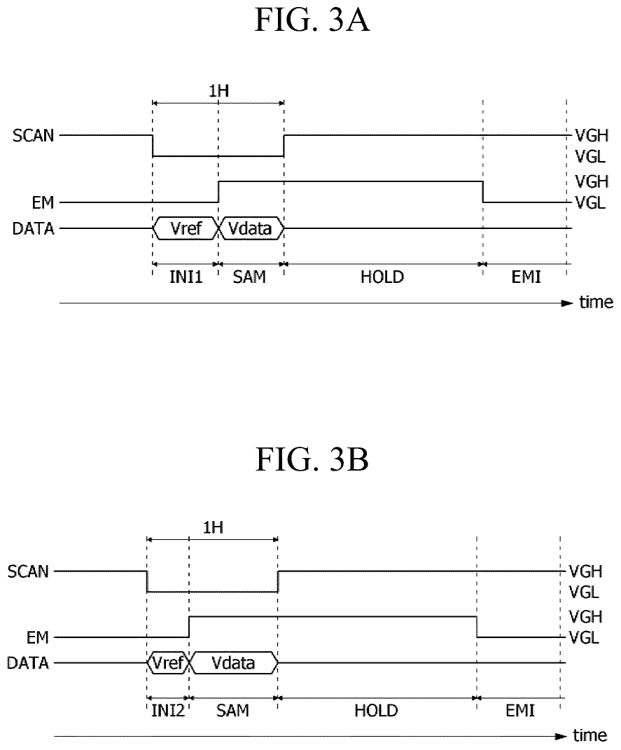

A driving period of the example pixel circuit illustrated in FIG. 2 may be divided into a first phase (or an initialization phase, INI) in which the pixel circuit is initialized, a second phase (or a sampling phase, SAM) in which the pixel data is written to the pixel circuit and a threshold voltage Vth of the driving element DT is sampled, and a third phase (or an emission phase, EMI) in which the light-emitting element EL is driven, as illustrated for example in FIGS. 3A and 3B. One (1) horizontal period (1H) may be divided into a first phase INI1/INI2 and a second phase SAM. The respective durations of the first phase INI1/INI2 and the second phase SAM may be appropriately selected based on the results of reliability experiments of the pixel circuit. For example, but without being so limited, each of the first phase INI1 and the second phase SAM may be set to a ½ horizontal duration, as shown in FIG. 3A, or the second phase SAM may be set to a longer duration compared to the first phase INI2, as shown in FIG. 3B. A hold phase HOLD may be set between the second phase SAM and the third phase EMI, but the hold phase may be omitted.

As shown in FIGS. 3A and 3B, a voltage of the first gate signal SCAN may be the gate-on voltage VGL in the first and second phases INI1/INI2 and SAM and may be the gate-off voltage VGH in the third phase EMI. A voltage of the second gate signal EM may be the gate-off voltage VGH in the second phase SAM and may be the gate-on voltage VGL in the first and third phases INI1/INI2 and EMI. During the hold phase HOLD, the voltage of the first and second gate signals SCAN and EM may be the gate-off voltage VGH.

A voltage on the data line DL may be the reference voltage Vref in the first phase INI1/INI2 and may be the data voltage Vdata in the second phase SAM for one horizontal period (1H) combined. By repeating the first phase INI1/INI2 and the second phase SAM every horizontal period, the data voltage Vdata corresponding to the pixel data value may be supplied to the pixel circuit in each pixel line.

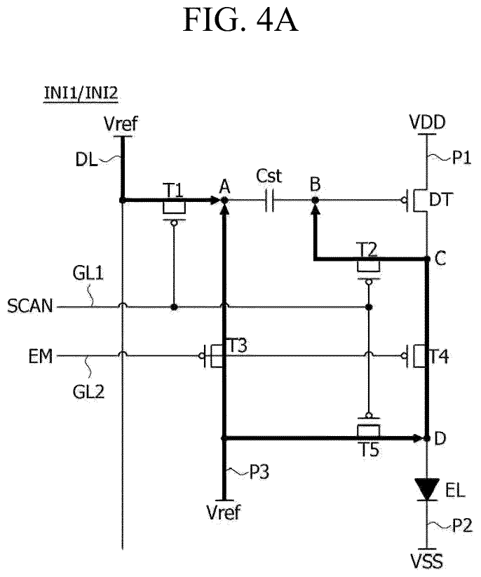

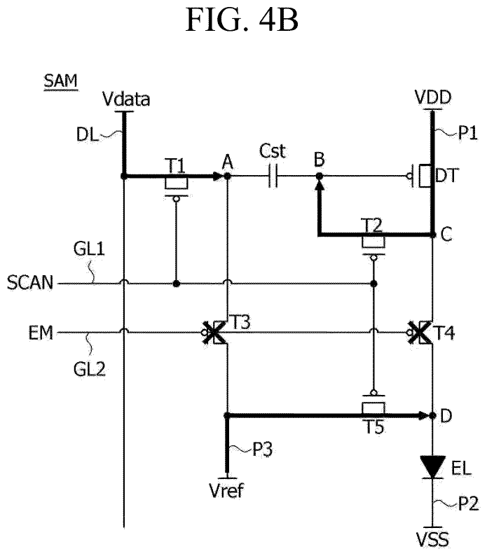

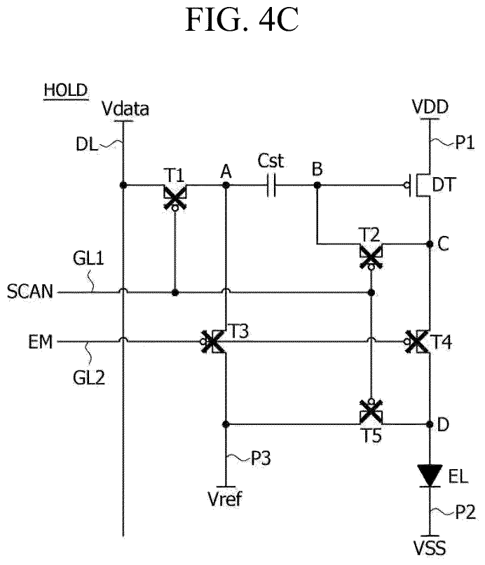

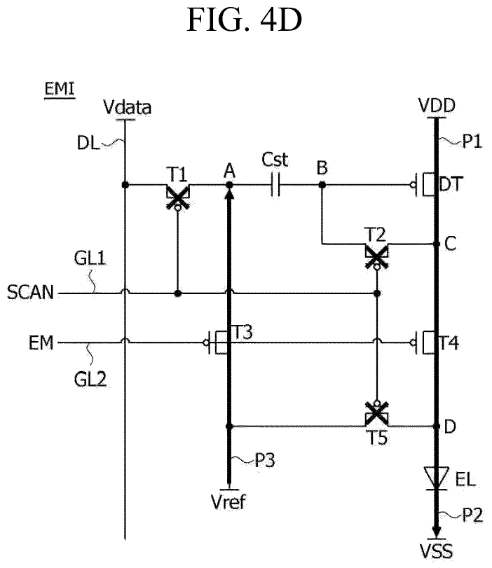

FIG. 4A is a circuit diagram illustrating a current flow of the example pixel circuit and voltages of major nodes in the first phase INI1/INI2.

As shown in FIG. 3A, FIG. 3B, and FIG. 4A, in the first phase INI1/INI2, the voltage of the first and second gate signals SCAN and EM may be the gate-on voltage VGL. Therefore, in the first phase INI1/INI2, the second to fifth switch elements T2 to T5 and the driving element DT may turn on to initialize the first to the fourth nodes A to D and the capacitor Cst.

In the first phase INI1/INI2, the reference voltage Vref may be applied to the data line DL. In the first phase INI1/INI2, the voltage of the first to fourth nodes A, B, C, and D may be the reference voltage Vref. In this case, the data line DL and the Vref node P3 may be short-circuited, and the capacitor Cst may be initialized to 0 V because the voltages of the first and second nodes A and B are equal to the reference voltage Vref.

The light-emitting element EL may be in the off state in the first phase INI1/INI2 because the voltage difference between the reference voltage Vref and the cathode voltage VSS may be lower than the threshold voltage of the light-emitting element EL in the first phase INI1/INI2.

Meanwhile, if the data voltage Vdata of the pixel data is applied to the data line DL in the first phase INI1/INI2, the data voltage Vdata and the reference voltage Vref may be short-circuited at the first node A, and thus the capacitor Cst may be unstably initialized. In the present disclosure, the reference voltage Vref may be applied to the data line DL in the first phase INI1/INI2 so that the reference voltage Vref is applied across the capacitor Cst, thereby initializing the voltage of the capacitor Cst to 0V equally in all pixels.

FIG. 4B is a circuit diagram illustrating a current flow of the example pixel circuit and voltages of major nodes in the second phase SAM.

As illustrated in FIGS. 3A, 3B, and 4B, in the second phase SAM, the threshold voltage Vth of the driving element DT and the data voltage Vdata of the pixel data may be applied to the capacitor Cst. In the second phase SAM, the pixel data may be written to the pixel circuit, the threshold voltage Vth of the driving element DT may be sampled, and the data voltage Vdata compensated by the threshold voltage Vth may be stored in the capacitor Cst.

In the second phase SAM, the data voltage Vdata of the pixel data may be applied to the data line DL, and the voltage of the first gate signal SCAN may be the gate-on voltage VGL. Here, the voltage of the second gate signal EM may be the gate-off voltage VGH. Therefore, in the second phase SAM, the first, second, and fifth switch elements T1, T2, and T5 may be turned on, while the third and fourth switch elements T3 and T4 are turned off.

At the end of the second phase SAM, the voltage of the first node A may be the data voltage Vdata of the pixel data, and the voltage of the third node B may be a voltage of VDD-Vth. Here, “Vth” is the threshold voltage of the driving element DT. In the second phase SAM, the voltage of the third node C may be VDD.

A hold phase HOLD may be set between the second phase SAM and the third phase EMI. During the hold phase HOLD, the voltage of the gate signals SCAN and EM may be the gate-off voltage VGH. In this case, since the first to fifth switch elements T1 to T5 are in an off state, the first, second, and fourth nodes A, B, and D may be floated to maintain their respective voltages from the previous stage. This is illustrated, for example, in FIG. 4C.

FIG. 4D is a circuit diagram illustrating a current flow of the pixel circuit and voltages of major nodes in the third phase EMI.

As shown in FIG. 3A, FIG. 3B, and FIG. 4D, in the third phase EMI, the voltage of the first gate signal SCAN may be the gate-off voltage VGH, and the voltage of the second gate signal EM may be the gate-on voltage VGL. Therefore, in the third phase EMI, the first, second, and fifth switch elements T1, T2, and T5 may be turned off, while the third and fourth switch elements T3 and T4 are turned on.

In the third phase EMI, the reference voltage Vref may be applied to the first node A, and thus the data voltage Vdata may be transferred to the second node B through capacitor coupling. In this case, the voltage of the first node A may be a voltage of (Vref−Vth), and the voltage of the second node B may be a voltage of VDD−Vth+(Vref−Vdata). In the third phase EMI, the light-emitting element EL may emit light in response to a current from the driving element DT. In the third phase EMI, the current (I) flowing through the light-emitting element EL may be represented as:

I=k(VDD−(VDD−Vth+(Vref−Vdata))−Vth)²=k(Vdata−Vref)².

Here, k is a constant value. Therefore, the light-emitting element EL may emit light at a luminance corresponding to a luminance value (or a grayscale value) of the pixel data without being affected by the deviation of the threshold voltage Vth of the driving element DT and the deviation of the constant voltages VDD, VSS, and Vref in the third phase EMI.

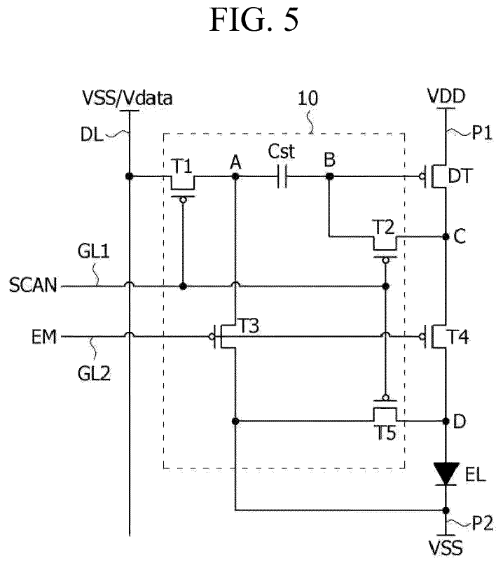

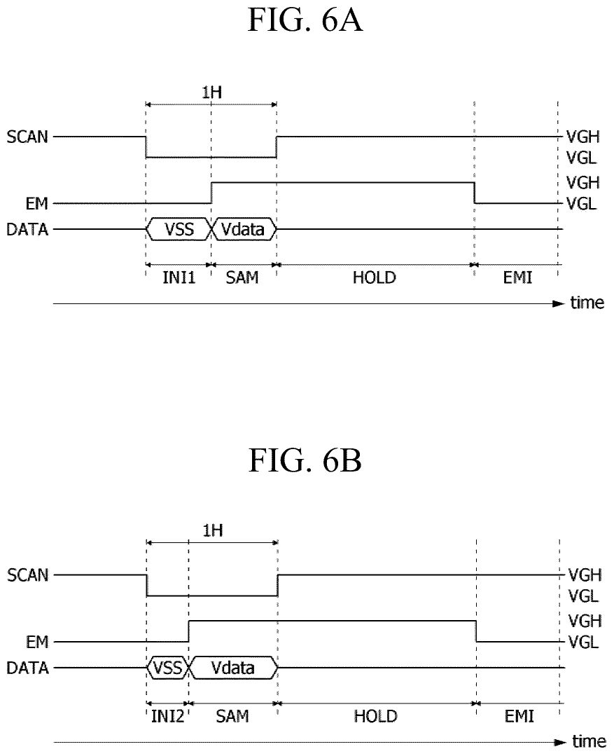

FIG. 5 is a circuit diagram illustrating a pixel circuit according to another example embodiment of the present disclosure. In FIG. 5, components substantially the same as those in the example of FIG. 2 are given the same reference numerals, and detailed description thereof may be omitted. Signals illustrated in FIGS. 6A and 6B are applied to the example pixel circuit shown in FIG. 5.

As shown in FIG. 5, FIG. 6A, and FIG. 6B, the third to fifth switch elements T3, T4, and T5 may initialize the first to the fourth nodes A, B, C, and D and the capacitor Cst with the cathode voltage VSS. Therefore, the example pixel circuit shown in FIG. 5 does not require a power line connecting to the Vref node P3 shown in the example of FIG. 2.

The third and fourth switch elements T3 and T4 may turn on in response to the gate-on voltage VGL of the second gate signal EM in the first and third phases INI1/INI2 and EMI. The third switch element T3 may turn off in response to the gate-off voltage VGL of the second gate signal EM in the second phase SAM and the hold period HOLD. The third switch element T3 may include a gate electrode connected to the second gate line GL2 to which the second gate signal EM is applied, a first electrode connected to the first node A, and a second electrode connected to the VSS node P2. The fourth switch element T4 may include a gate electrode connected to the second gate line GL2, a first electrode connected to the third node C, and a second electrode connected to the fourth node D.

The fifth switch element T5 may turn on in response to the gate-on voltage VGL of the first gate signal SCAN in the first and second phases INI1/INI2 and SAM. The fifth switch element T5 may turn off in response to the gate-off voltage VGH of the first gate signal SCAN in the hold phase HOLD and the third phase EMI. The fifth switch element T5 may include a gate electrode connected to the first gate line GL1 to which the first gate signal SCAN is applied, a first electrode connected to the VSS node P2, and a second electrode connected to the fourth node D.

In the first phase INI1/INI2, a voltage of the first and second gate signals SCAN and EM may be the gate-on voltage VGL. Therefore, in the first phase INI1/INI2, the second to fifth switch elements T2 to T5 and the driving element DT may turn on to initialize the first to the fourth nodes A to D and the capacitor Cst.

In the first phase INI1/INI2 of the example pixel circuit shown in FIG. 5, the cathode voltage VSS may be applied to the data line DL. In the first phase INI1/INI2, respective voltages of the first to fourth nodes A, B, C, and D may be initialized to the cathode voltage VSS.

The light-emitting element EL may be in the off state in the first phase INI1/INI2 because the voltage difference between the reference voltage Vref and the cathode voltage VSS may be lower than the threshold voltage of the light-emitting element EL in the first phase INI1/INI2. In the first phase INI1/INI2 of the example pixel circuit shown in FIG. 5, the cathode voltage VSS may be applied to the data line DL, and thus the cathode voltage VSS may be applied across the capacitor Cst.

As may be seen from the foregoing example embodiments, in the first phase INI1/INI2 in which the pixel circuit according to an example embodiment of the present disclosure is initialized, the reference voltage Vref may be applied to the first node A through the data line DL and the first switch element T1 and simultaneously through the third switch element T3, or the cathode voltage VSS may be applied to the first node A through the data line DL and the first switch element T1 and simultaneously through the third switch element T3. Therefore, the same initialization voltage (either Vref or VSS) may be applied to the first node A via two paths when the pixel circuit is initialized.

As shown in FIGS. 6A and 6B, the voltage of the first gate signal SCAN may be the gate-on voltage VGL in the first and second phases INI1/INI2 and SAM, and may be the gate-off voltage VGH in the third phase EMI. A voltage of the second gate signal EM may be the gate-off voltage VGH in the second phase SAM and may be the gate-on voltage VGL in the first and third phases INI1/INI2 and EMI. During the hold phase HOLD, the respective voltages of the first and second gate signals SCAN and EM may be the gate-off voltage VGH.

A voltage on the data line DL may be the cathode voltage VSS in the first phase INI1/INI2 and may be the data voltage Vdata in the second phase SAM for one horizontal period (1H) combined. By repeating the first phase INI1/INI2 and the second phase SAM every horizontal period, the data voltage Vdata corresponding to the pixel data value may be supplied to the pixel circuit in each pixel line.

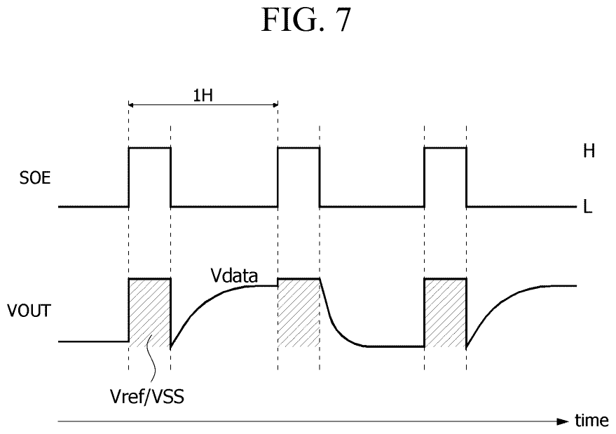

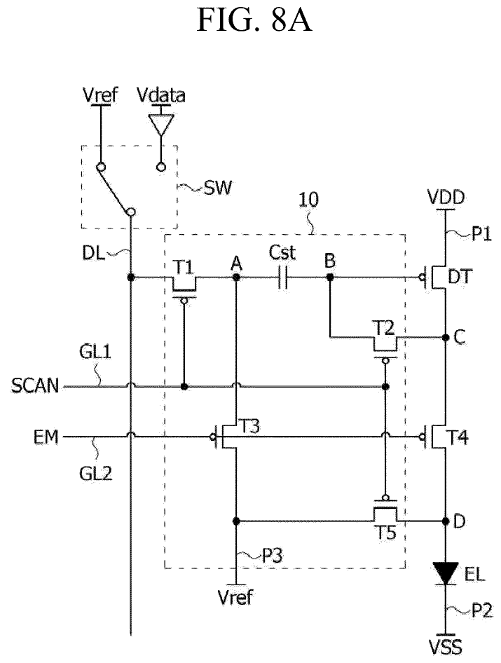

FIG. 7 is a waveform diagram illustrating an output voltage from a data driver according to an example embodiment of the present disclosure.

As illustrated in FIG. 7, the data driver may supply the initialization voltage Vref/VSS for the pixel circuit to the data line DL at each horizontal period, followed by the data voltage Vdata to the data line.

The data driver may output the initialization voltage Vref/VSS and the data voltage Vdata to the data line DL in synchronization with a timing signal having a cycle of one horizontal period, for example, a source output enable signal SOE. The data driver may output the initialization voltage Vref/VSS in response to a logic high voltage (H) of the source output enable signal SOE and may output the data voltage Vdata in response to a logic low voltage (L) of the source output enable signal SOE. The timing signal having the cycle of one horizontal period is not limited to the source output enable signal SOE.

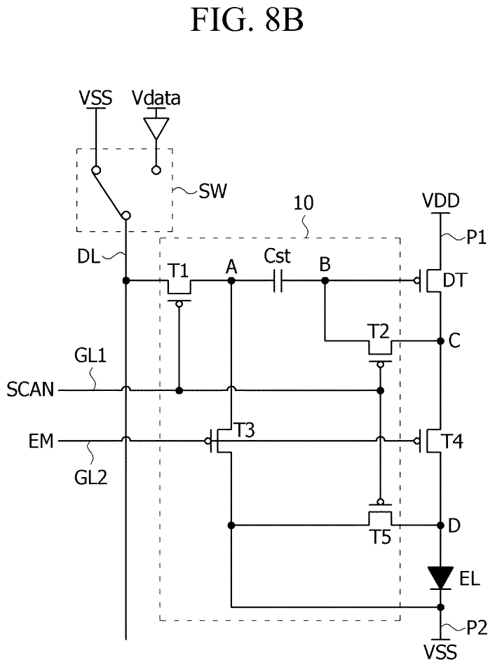

FIGS. 8A and 8B are diagrams illustrating an example switch circuit connected to a data line.

As shown in FIGS. 8A and 8B, a switch circuit SW may be connected to the data line DL. The switch circuit SW may output the initialization voltage Vref/VSS, followed by the data voltage Vdata. The initialization voltage Vref/VSS applied to the data line DL via the switch circuit SW may be the same voltage as the reference voltage Vref (or the cathode voltage VSS) applied to the pixel circuit, or it may be set to a voltage appropriately adjusted in consideration of the characteristics of the display panel. The switch circuit SW may, but is not limited to, operate in cycles such as a one horizontal period, a ½ horizontal period, a ⅓ horizontal period, and a ¼ horizontal period in synchronization with a timing control signal generated in the timing controller or the data driver.

The switch circuits SW may be disposed at each data output channel of an integrated circuit (IC) in which the data driver is integrated. The switch circuit SW may be disposed outside the data driver. For example, the switch circuit SW may be disposed in a non-display area of the display panel. The switch circuit SW may alternately select the initialization voltage Vref/VSS and the data voltage Vdata to supply the same to the data line DL. Within one horizontal period, after the initialization voltage Vref/VSS is applied to the data lines DL through the switch circuit SW, the data voltage Vdata may be applied to the data lines DL.

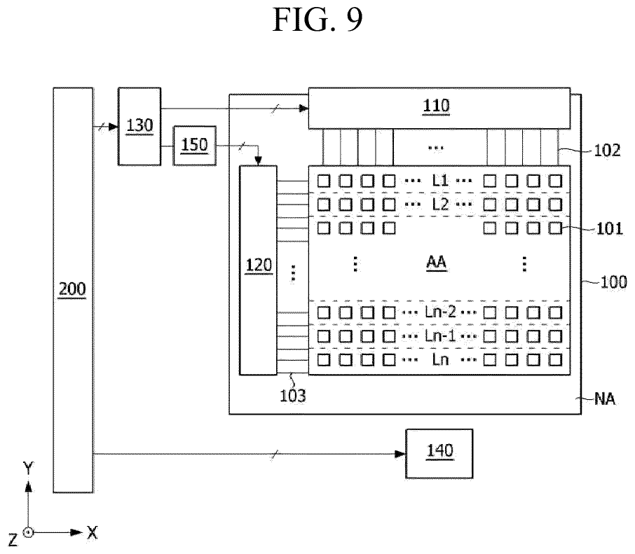

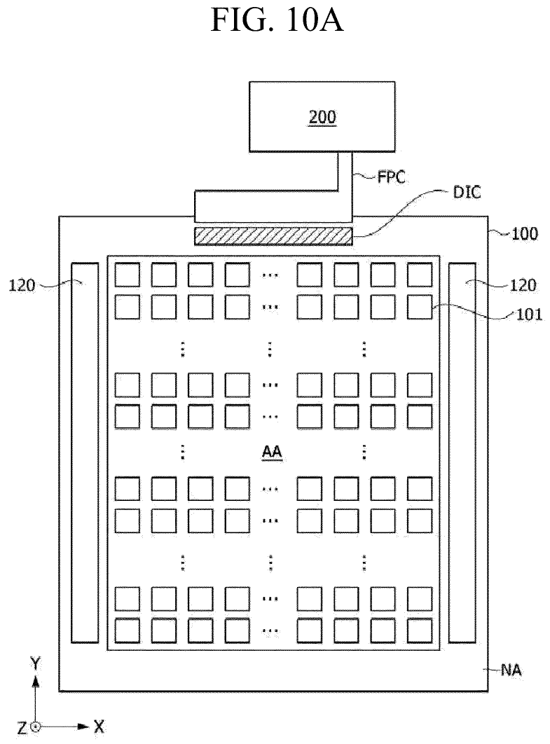

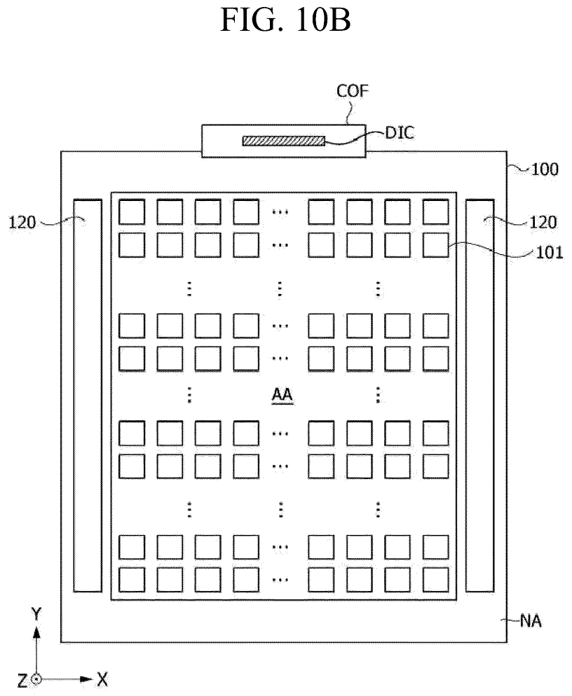

FIG. 9 is a block diagram illustrating a display device according to an example embodiment of the present disclosure. FIGS. 10A and 10B are diagrams illustrating other examples of the display device.

As shown in FIGS. 9 to 10B, a display device according to example embodiments of the present disclosure may include a display panel 100, a display panel driving circuit for writing pixel data to pixels 101 of the display panel 100, and a power supply 140 for generating power for driving the pixels 101 and the display panel driving circuit.

A substrate of the display panel 100 may be, but is not limited to, a plastic substrate, a thin glass substrate, or a metal substrate. In a stretchable display device, the substrate of the display panel may be made of a stretchable insulating material, for example, a silicone rubber such as polydimethylsiloxane (PDMS), polyurethane (PU), or an elastomer such as polytetrafluoroethylene (PTFE).

The display panel 100 may be, but is not limited to, a rectangular shaped panel having a length in the X-axis direction (or the first direction), a width in the Y-axis direction (or the second direction), and a thickness in the Z-axis direction (or the third direction). For example, at least a portion of the display panel 100 may have a curved perimeter.

A display area AA of the display panel 100 may include a pixel array for displaying an input image thereon. The pixel array may include a plurality of data lines 102, a plurality of gate lines 103 intersecting the data lines 102, and the pixels 101 arranged in a matrix form. The display panel 100 may further include power lines commonly connected to the pixels 101. The power lines may be connected to constant voltage nodes P1, P2, and P3 of the pixel circuits to supply the pixels 101 with constant voltages VDD, VSS, and Vref, respectively, to drive the pixels 101. The power lines may be implemented as long stripes of wirings along either the first or second direction, or as mesh wirings where the wirings in the first direction and the wirings in the second direction are electrically connected. The power lines may further include a VGL line and a VGH line that are connected to a gate driver 120. A gate-on voltage VGL may be applied to the VGL line and a gate-off voltage VGH may be applied to the VGH line.

Each of the pixels 101 may include a red sub-pixel, a green sub-pixel, and a blue sub-pixel for color implementation. Each of the pixels may further include a white sub-pixel. Each sub-pixel may include a pixel circuit for driving a light-emitting element. Each of the pixel circuits may be connected to the data lines, the gate lines, and the power lines. Hereinafter, a “pixel” may be understood as having the same meaning as a “sub-pixel.” The pixel circuit may be implemented as one of the example pixel circuits shown in FIGS. 1 to 8B.

The pixels may be arranged in the form of real color pixels and pentile pixels. A pentile pixel may realize a higher resolution than a real color pixel by driving two sub-pixels having different colors as one pixel 101 by using a preset pixel rendering algorithm. The pixel rendering algorithm may compensate for inadequate color representation in each pixel with the color of light emitted from its adjacent pixel.

The pixel array may include a plurality of pixel lines L1 to Ln. Each of the pixel lines L1 to Ln may include one line of pixels arranged along the line direction (X-axis direction) in the pixel array of the display panel 100. The pixels arranged in one pixel line may share one or more of the gate lines 103. The sub-pixels arranged in the column direction Y along the data line direction may share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on a screen and an actual object in the background are visible. The display panel 100 may be made as a flexible display panel.

The power supply 140 may generate constant voltages (or direct current (DC) voltages) for driving the pixel array and the display panel driving circuit of the display panel 100 by using a DC-DC converter. The DC-DC converter may include a charge pump, a regulator, a buck converter, a boost converter, and the like. The power supply 140 may output the constant voltages, such as a gamma reference voltage, a gate-on voltage VGL, a gate-off voltage VGH, a pixel driving voltage VDD, a cathode voltage VSS, a reference voltage Vref, and the like, by adjusting the level of a DC input voltage applied from a host system 200. The gamma reference voltage may be supplied to the data driver 110. A dynamic range of the data voltage output from the data driver 110 may be determined by a voltage range of the gamma reference voltage. The dynamic range of the data voltage may be the range of voltages between the uppermost grayscale voltage and the lowermost grayscale voltage.

The gate-on voltage VGL and the gate-off voltage VGH may be supplied to a level shifter 150 and the gate driver 120. The constant voltages, such as the pixel driving voltage VDD, the cathode voltage VSS, and the reference voltage Vref, may be supplied to the pixels 101 via the power lines commonly connected to the pixels 101.

The pixel driving voltage VDD may be supplied from a main power source in the host system 200 to the display panel 100. In this case, the power supply 140 may not need to output the pixel driving voltage VDD.

The display panel driving circuit may write the pixel data of the input image to the pixels of the display panel 100 under the control of the timing controller 130. The display panel driving circuit may include the data driver 110 and the gate driver 120.

The display panel driving circuit may further include a touch sensor driver for driving touch sensors. The touch sensor driver is not illustrated in FIG. 9 to FIG. 10B. The data driver 110 and the touch sensor driver may be integrated into a single drive integrated circuit (IC). In a mobile terminal or a wearable terminal, the timing controller 130, the power supply 140, the level shifter 150, the data driver 110, the touch sensor driver, and the like may be integrated into one drive IC (DIC) as shown, for example, in FIGS. 10A and 10B.

The data driver 110 may receive the pixel data of the input image received as a digital signal from the timing controller 130 and output the data voltage. The data driver 110 may output the data voltages by converting the pixel data of the input image into a gamma compensation voltage using a digital-to-analog converter (DAC). The gamma reference voltage may be divided into the gamma compensation voltage for each grayscale by a voltage divider circuit in the data driver 110, which is supplied to the DAC. The DAC may generate the data voltages as the gamma compensation voltages corresponding to the grayscale values of the pixel data. The data voltages output from the DAC may be output from the respective data output channels of the data drive 110 to the data lines 102 through the output buffers.

Initialization data REF may be provided to the data driver 110 as a digital signal from the timing controller 130. In this case, the data driver 110 may output the initialization voltage Vref/VSS in response to the initialization data REF. The initialization data REF may indicate the voltage level of the initialization voltage Vref/VSS.

The gate driver 120 may be formed on the display panel 100 together with a TFT array of the pixel array and the wires. The gate driver 120 may be disposed in the non-display area NA of the display panel 100 outside the display area AA, or at least a portion thereof may be disposed in the display area AA.

The gate driver 120 may include a plurality of shift registers for sequentially shifting pulses of the gate signals. The gate driver 120 may be disposed on either or both of a left non-display area NA and a right non-display area NA outside the display area AA in the display panel 100 to supply the gate signals to the gate lines 103 in a single feeding method. In the single feeding method, the gate signals may be applied at one end of the gate lines, respectively. The gate driver 120 may be disposed in both the left non-display area NA and the right non-display area NA of the display panel 100 to apply the gate signals to the gate lines 103 in a double feeding method. In the double feeding method, the gate signals are applied simultaneously at both ends of the gate lines 103, respectively. At least some circuits of the gate driver 120 may be disposed within the display area AA.

The gate driver 120 may sequentially output pulses of the gate signals to the gate lines 103 under the control of the timing controller 130. The gate driver 120 may sequentially supply the gate signals to the gate lines 103 by shifting the pulses of the gate signals using the shift registers. The gate driver 120 may utilize a plurality of shift registers to output a plurality of gate signals having different phases, pulse widths, etc. The gate signals may include the first gate signal SCAN and the second gate signal EM as described above.

The timing controller 130 may receive from the host system 200 the pixel data of the input image and a timing signal synchronized with the pixel data. The timing signal may include a vertical synchronization signal Vsync, a horizontal synchronization signal Hsync, and a data enable signal DE. Since a vertical period and a horizontal period may be known by counting the data enable signal DE, the vertical synchronization signal Vsync and the horizontal synchronization signal Hsync may be omitted. The data enable signal DE may have a cycle of one horizontal period (1H).

The timing controller 130 may control the data driver 110 and the gate driver 120 by generating signals or timing information to control the operation timing of the data driver 110 and the gate driver 120 based on the timing signals (e.g., Vsync, Hsync, and DE) received from the host system 200.

A gate timing control signal generated from the timing controller 130 may be input to the shift register of the gate driver 120 through the level shifter 150. The level shifter 150 may receive the gate timing control signal and generate a start pulse and a shift clock to provide them to shift registers in the gate driver 120. An input signal to the level shifter 150 may be a signal of a digital voltage signal level, and an output signal from the level shifter 150 may be an analog voltage signal that swings between the gate-on voltage VGL and the gate-off voltage VGH. The data timing control signal generated from the timing controller 130 may be transmitted to the data driver 110. The data driver 110 may generate the source output enable signal SOE from the received data timing control signal.

The host system 200 may scale an image signal from a video source to match the resolution of the display panel 100 and may transmit the scaled image signal to the timing controller 130 together with the timing signal. In a mobile system, the host system 200 may be implemented with an application processor (AP). The host system 200 may transmit the pixel data of the input image to the drive IC (DIC) shown, for example, in FIGS. 10A and 10B through a mobile industry processor interface (MIPI). The host system 200 may be electrically connected to the drive IC (DIC) through a flexible printed circuit, for example, a flexible printed circuit (FPC), as shown in FIG. 10A. The drive IC (DIC) may be attached on the display panel 100 during a chip on glass (COG) process as shown, for example, in FIG. 10A. The drive IC (DIC) may be electrically connected to the wires on the display panel 100 as a chip on film (COF) structure mounted on a flexible circuit film, for example, as shown in FIG. 10B.

The timing controller 130 or the host system 200 may enter a low power mode to reduce power consumption of the display device when a still image or always on display (AOD) data is input. In a normal mode, the pixels 101 may have a refresh rate of 60 Hz, 144 Hz, 240 Hz, or the like. The refresh rate is the frequency at which pixel data is written to the pixels 101. In the low power mode, the refresh rate of the pixels 101 may be lowered to a frequency lower than 60 Hz, for example, 1 Hz to 30 Hz. When the refresh rate is 1 Hz, a first frame out of 60 frames per second, may be a refresh frame, and the next 59 frames may be holding frames. After a data voltage Vdata of the pixel data is charged to the pixels 101 during a refresh frame period, the pixels 101 may maintain the data voltage charged in a previous refresh frame without newly charging the data voltage Vdata during the continuous subsequent holding frame periods to maintain an emitting state.

The example switch circuit SW shown in FIGS. 8A and 8B may be disposed in the non-display area NA of the display panel 100 or may be disposed in a data output channel of the data driver 110.

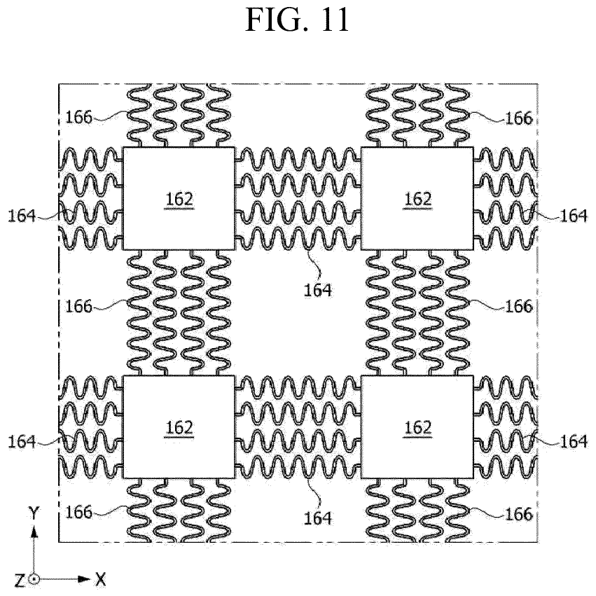

FIG. 11 is a diagram showing an example of circuit parts and stretch wires of a stretchable display device.

As shown in FIG. 11, a display panel of the stretchable display device may include a plurality of circuit parts 162 spaced apart on a stretchable substrate, and stretchable wires 164 and 166 electrically connecting the circuit parts 162.

The data lines 102, gate lines 103, power lines, and clock lines connected to the shift register of the gate driver 120 (see, e.g., FIGS. 9-10B) may be implemented as stretchable wires 164 and 166 disposed on the stretchable substrate.

The stretchable wires 164 and 166 may include a plurality of first directional stretchable wires 164 and a plurality of second directional stretchable wires 166. The first directional stretchable wires 164 may extend along the first direction X to electrically connect the adjacent circuit parts 162 in the first direction X. The second directional stretchable wires 166 may extend along the second direction Y to electrically connect the adjacent circuit parts 162 in the second direction Y. The stretchable wires 164 and 166 may be implemented as a sufficiently stretchable wiring pattern, such as a zigzag wiring or a wavy wiring. For a mesh wiring, the first directional stretchable wires 164 and the second directional stretchable wires 166 may be connected at the circuit part 162.

In the display area AA, each of the circuit parts 162 may include one or more pixel circuits. The circuits in the gate driver 120 may be distributed among the circuit parts 162 disposed in the non-display area NA and/or the displayed area AA. Where the switch circuit SW is disposed in the non-display area NA of the display panel 100, the switch circuit SW may be disposed in the circuit part 162 in the non-display area NA.

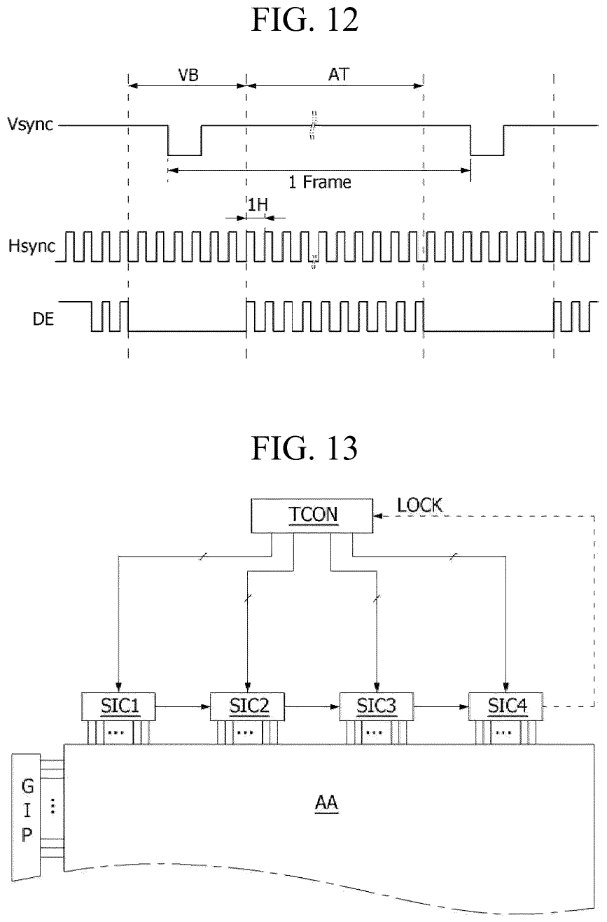

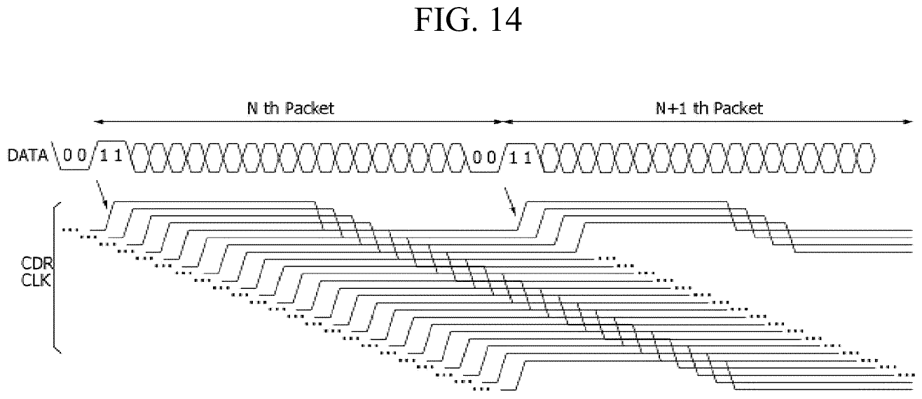

FIG. 12 is a diagram illustrating one frame period and one horizontal period according to an example embodiment of the present disclosure. FIG. 13 is a diagram illustrating an example transmission line connection structure between a timing controller and drive ICs on an EPI interface. FIG. 14 is a waveform diagram illustrating an example of a multi-phase internal clock generated by drive ICs. A drive IC may include the data driver 110. In FIG. 13, “GIP” denotes the gate driver 120.

As shown in FIGS. 12, 13, and 14, a vertical synchronization signal (Vsync) may define one frame period. A horizontal synchronization signal Hsync may define one horizontal period (1H). A data enable signal DE may define an effective data section including pixel data to be written to the pixels. A pulse of the data enable signal DE may be synchronized with the pixel data to be written to the pixels 101 of the display panel 100. One pulse cycle of the data enable signal DE may be one horizontal period (1H).

One frame period may be divided into an active interval AT in which the pixel data of the input image is written to the pixels 101, and a vertical blank period VB having no pixel data.

The timing controller TCON may send data to the data driver 110 of the drive ICs SIC1 to SIC4 through the Embedded Clock Point to Point Interface (EPI). Although four drive ICs are illustrated in FIG. 13, additional drive ICs may be added depending on the size and resolution of the display panel 100.

The EPI interface may connect the timing controller TCON and the drive ICs SIC1 to SIC4 in a point-to-point fashion, as shown for example in FIG. 13, to minimize the number of wires needed in transmission lines between the timing controller TCON and the drive ICs SIC1 to SIC4. The transmission lines that connect the timing controller TCON and the drive ICs SIC1 to SIC4 in a point-to-point fashion may include data wire pairs. In the EPI interface, signals with a built-in clock may be transmitted through a data wire pair. The signals with a built-in clock may include control data to control the data drivers of the drive ICs SIC1 to SIC4 and the gate driver GIP, and pixel data to be written to the pixels to reproduce the input image on the display area AA. Therefore, the EPI interface may not require separate clock and control wires because the signals including clock, control data, and pixel data are transmitted in series through the same wire pair.

For the EPI interface, each of the drive ICs SIC1 to SIC4 may include a clock restoration circuit for clock and data recovery (CDR). The timing controller TCON may send a clock training pattern (or preamble) signal to the drive ICs SIC1 to SIC4 so that the phase and frequency of the clock being restored may be locked in the drive ICs SIC1 to SIC4. When the clock training pattern signal and the clock bit in the signal DATA received in series are input through the data wire pair, the drive ICs SIC1 to SIC4 may restore the clock from the clock bit to generate a multi-phase internal clock CDR CLK as shown, for example, in FIG. 14. In FIG. 14, “0011” is an example of a clock bit that is serially transmitted to the drive ICs SIC1 to SIC4. The clock bit may be encoded between data packets.

When the internal clock CDR CLK is locked in phase and frequency, the drive ICs SIC1 to SIC4 may feed a high logic level lock signal LOCK back to the timing controller TCON, which indicates the steady state of the output. The lock signal LOCK may be sequentially transmitted from a first drive IC SIC1 to a fourth drive IC SIC4, and the lock signal LOCK may be fed back from the fourth drive IC SIC4 to the timing controller TCON through a lock feedback wire.

In a signal transfer protocol of the EPI interface, the timing controller TCON may send the clock training pattern signal to the drive ICs SIC1 to SIC4 before sending the control data and the pixel data of the input image. The drive ICs SIC1 to SIC4 may restore the clock from the signal DATA received over the data wire pair by performing a clock training when the clock training pattern signal is received to generate an internal clock, and may send the lock signal LOCK to the timing controller TCON to allow a data link to be established with the timing controller TCON when the phase and frequency of the internal clock are stably fixed in all the drive ICs SIC1 to SIC4.

In response to the lock signal LOCK received from the last drive IC SIC4, the timing controller TCON may encode the control data and the pixel data and may begin transmitting them to the drive ICs SIC1 to SIC4 over the data wire pair. The signal DATA output from the timing controller TCON may be converted into a differential signal through a transmitting end buffer of the timing controller TCON and be transmitted to the drive ICs SIC1 to SIC4 over the data wire pair. The wire pair may include a first wire over which a forward phase signal of the differential signal is transmitted, and a second wire over which a reverse phase signal of the differential signal is transmitted.

The drive ICs SIC1 to SIC4 may restore the control data by sampling control data bits from the signal DATA received via the data wire pair to an internal clock timing, and may restore a data timing control signal, a gate timing control signal, and the like from the restored control data.

The drive ICs SIC1 to SIC4 may sample bits of pixel data from the signal DATA received via the wire pair according to the internal clock timing, and then may convert the bits of the sampled pixel data into parallel data using a latch. And the drive ICs SIC1 to SIC4 may convert the pixel data into a data voltage and may output the same through an output buffer. The data voltage may be supplied to the data lines of the display panel 100.

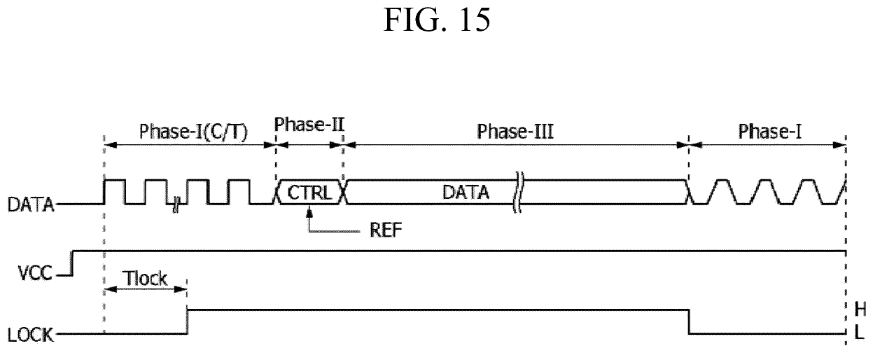

FIG. 15 is a waveform diagram illustrating an example of a signal transfer protocol for an EPI interface.

As illustrated in FIG. 15, the timing controller TCON may transmit a clock training pattern signal C/T of a constant frequency to the drive ICs SIC1 to SIC4 in a first phase Phase-I. When a high logic level (H) lock signal LOCK is input via the lock feedback wire, the timing controller TCON may perform a second phase Phase-II to convert the signal DATA encoded in the signal format defined by the EPI interface protocol into the differential signal and may begin to transmit it via the wire pair. In the second phase Phase-II, a control data packet CTRL may be sent to the drive ICs SIC1 to SIC4.

Following the second phase Phase-II, the timing controller TCON may perform a third phase Phase-III when the lock signal LOCK is held at a high logic level to transmit video data packets including the pixel data DATA of the input image to the drive ICs SIC1 to SIC4.

In FIG. 15, “Tlock” is a delay time until the lock signal LOCK is inverted into the high logic level (H). During the delay time Tlock, the clock training pattern signal C/T may be sent to the drive ICs SIC1 to SIC4 to lock the frequency and phase of the internal clock, which has been restored by performing the clock training process in the drive ICs SIC1 to SIC4.

The timing controller TCON may re-execute the first phase Phase-I to resume the clock training for the drive ICs SIC1 to SIC4 when a low logic level (L) lock signal LOCK is input from the last drive IC SIC4, and may transmit the clock training pattern signal C/T to the drive ICs SIC1 to SIC4. If the lock signal LOCK is inverted to the low logic level (L) in any one of the drive ICs SIC1 to SIC4 in an unexpected situation during the execution of the second phase Phase-II or the third phase Phase-III, the timing controller TCON may execute the first phase Phase-I and may send the clock training pattern signal C/T to the drive ICs SIC1 to SIC4 even if the Phase-II or the Phase-III is being executed. In this case, the control data CTRL and the pixel data DATA are not received by the drive ICs SIC1 to SIC4.

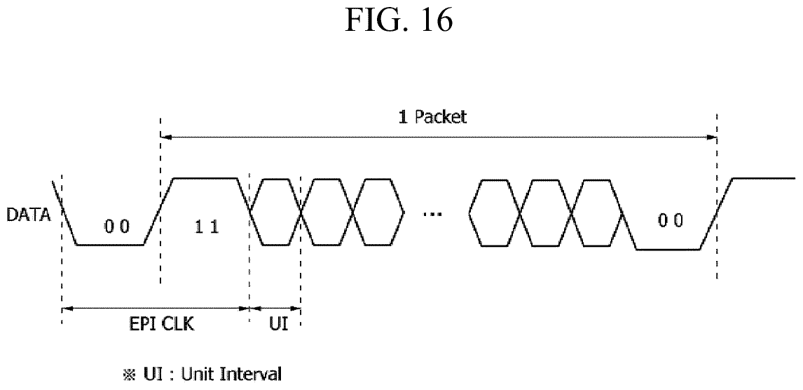

FIG. 16 is a diagram illustrating an example of one (1) data packet in the EPI interface.

As illustrated in FIG. 16, one data packet of the signal DATA sent to the drive ICs SIC1 to SIC4 may include data bits, and clock bits EPI CLK allocated before and after the data bits. One-bit transfer time may be one UI (Unit Interval) time. The one UI may vary depending on a resolution of the display panel 100 or the number of data bits.

The clock bits EPI CLK may be allocated by 4 UIs between adjacent data packets, and their logical value may be set to, but is not limited to, “0 0 1 1 (or L L H H)”. Where the number of bits per color in 4 sub-color data is 10 bits, a data packet of one pixel data may include 40 UI data bits and 4 UI clock bits. Where the number of data bits is 8 bits and the pixel data includes R, G, and B data without white data W, one data packet may include 24 UI data bits including 8 bits of R sub-pixel data, 8 bits of G sub-pixel data, and 8 bits of B sub-pixel data, and 4 UI clock bits.

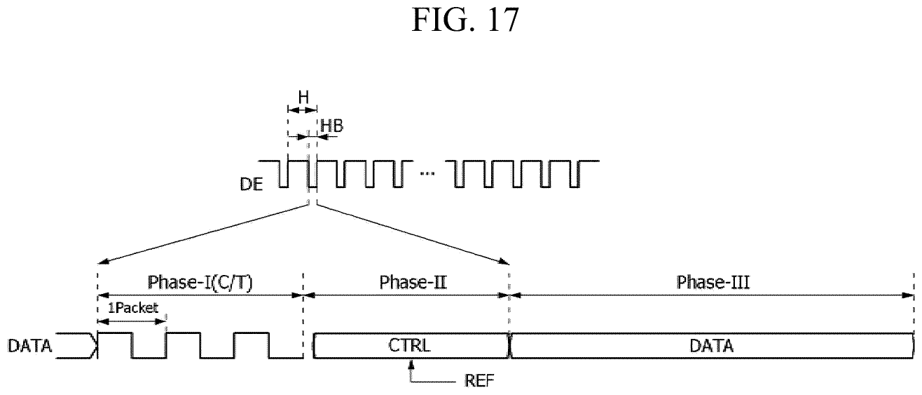

FIG. 17 is a diagram illustrating an example of a signal transmitted during a horizontal blank period.

As illustrated in FIG. 17, one horizontal period (1H) may be divided into a horizontal blank period HB in which there is no pixel data transmitted, and a horizontal active period HA in which the pixel data DATA is transmitted. The control data packets may be transmitted to the drive ICs SIC1 to SIC4 in the horizontal blank period HB.

The first phase Phase-I and the second phase Phase-II may be performed during the horizontal blank period HB. The horizontal blank period HB may correspond to a low logic level interval of the data enable signal DE. During the horizontal blank period HB, one or more control data packets CTRL may be transmitted. As shown in FIGS. 15 and 17, initialization data REF indicative of the voltage level of the initialization voltage Vref/VSS may be encoded in the control data packets CTRL.

The data driver of the drive ICs SIC1 to SIC4 may sample and latch the initialization data REF and may supply the initialization data REF to the DAC, which outputs the initialization voltage Vref/VSS having the voltage level indicated by the initialization data REF. Since the initialization data REF is updated every horizontal period, the initialization voltage Vref/VSS may be applied as the same or different voltages for each pixel line L1 to Ln. Where the initialization data REF is a 4-bit data, the initialization voltage Vref/VSS may be selected from voltages subdivided into 16 steps. By using this, the initialization voltage Vref/VSS may be applied as an optimum voltage depending on the position of the display panel 100. For example, the reference voltage Vref may increase as the distance from the drive IC increases, taking into account the voltage drop of the voltage applied to the power line of the display panel.

According to one or more example embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more example embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims. Thus, the scope of the claims is not limited to the above description of the present disclosure.

It will be apparent to those skilled in the art that the present disclosure is not limited by the above-described example embodiments and the accompanying drawings, and that various substitutions, modifications, and variations can be made in the present disclosure without departing from the spirit or scope of the disclosures. Therefore, the above example embodiments of the present disclosure are provided for illustrative purposes and are not intended to limit the scope or technical concept of the present disclosure. The protective scope of the present disclosure should be construed based on the following claims and their equivalents, and it is intended that the present disclosure cover all modifications and variations of this disclosure that come within the scope of the claims and their equivalents.

What is claimed is:

1. A pixel circuit, comprising:
a compensation circuit connected to a data line, a first gate line, and a second gate line, the compensation circuit being configured to receive first and second voltages alternately through the data line, a first gate signal through the first gate line, and a second gate signal through the second gate line;
a light-emitting element;
a driving element including a gate electrode configured to receive the second voltage via the compensation circuit, the driving element being configured to generate a current to drive the light-emitting element based on the second voltage; and
a switch element including a gate electrode configured to receive the second gate signal via the compensation circuit, the switch element being configured to switch a path of the current between the driving element and the light-emitting element based on the second gate signal,
wherein the light-emitting element, the driving element, and the switch element are connected in series between a first power line and a second power line.

2. The pixel circuit of claim 1, wherein:
the compensation circuit includes:
a capacitor coupled between a first node and a second node;
a first switch element connected between the data line and the first node and configured to turn on in response to a gate-on voltage of the first gate signal to electrically connect the data line to the first node;
a second switch element connected between the second node and a third node and configured to turn on in response to the gate-on voltage of the first gate signal to electrically connect the second node to the third node;
a third switch element connected to the first node and configured to turn on in response to a gate-on voltage of the second gate signal to apply the first voltage to the first node; and
a fifth switch element connected to a fourth node and configured to turn on in response to the gate-on voltage of the first gate signal to apply the first voltage to the fourth node;
the switch element includes a fourth switch element connected between the third node and the fourth node and configured to turn on in response to the gate-on voltage of the second gate signal to electrically connect the third node to the fourth node;
the driving element includes a gate electrode connected to the second node, a first electrode connected to the first power line configured to receive a pixel driving voltage, and a second electrode connected to the third node;
the light-emitting element includes an anode electrode connected to the fourth node, and a cathode electrode connected to the second power line configured to receive a cathode voltage;
the first voltage is a reference voltage or the cathode voltage, and the second voltage is a data voltage of pixel data; and
the data line is configured to receive the data voltage of pixel data after receiving the reference voltage or the cathode voltage.

3. The pixel circuit of claim 2, wherein during one horizontal period, the first node is configured to receive the reference voltage simultaneously via the data line and the first switch element as via the third switch element.

4. The pixel circuit of claim 3, wherein the second node, the third node, and the fourth node are configured to receive the reference voltage when the reference voltage is applied to the first node.

5. The pixel circuit of claim 3, wherein:
a driving period of the pixel circuit includes a first phase in which the pixel circuit is configured to be initialized, a second phase in which the capacitor is configured to receive a threshold voltage of the driving element and the data voltage, and a third phase in which the light-emitting element is configured to emit light;
the first gate signal is configured to be at the gate-on voltage in the first phase and the second phase, and at the gate-off voltage in the third phase;
the second gate signal is configured to be at the gate-off voltage in the second phase, and at the gate-on voltage in the first and third phases;
the first, second, and fifth switch elements are configured to turn on in response to the gate-on voltage of the first gate signal and to turn off in response to the gate-off voltage of the first gate signal;
the third and fourth switch elements are configured to turn on in response to the gate-on voltage of the second gate signal and to turn off in response to the gate-off voltage of the second gate signal;
the one horizontal period includes periods of the first phase and the second phase; and
the data line is configured to be at the reference voltage in the first phase and at the data voltage in the second phase.

6. The pixel circuit of claim 5, wherein:
the first switch element includes a gate electrode configured to receive the first gate signal, a first electrode connected to the data line, and a second electrode connected to the first node;
the second switch element includes a gate electrode configured to receive the first gate signal, a first electrode connected to the second node, and a second electrode connected to the third node;
the third switch element includes a gate electrode configured to receive the second gate signal, a first electrode connected to the first node, and a second electrode configured to receive the reference voltage;
the fourth switch element includes a gate electrode configured to receive the second gate signal, a first electrode connected to the third node, and a second electrode connected to the fourth node; and
the fifth switch element includes a gate electrode configured to receive the first gate signal, a first electrode configured to receive the reference voltage, and a second electrode connected to the fourth node.

7. The pixel circuit of claim 2, wherein during one horizontal period, the first node is configured to receive the cathode voltage simultaneously via the data line and the first switch element as via the third switch element.

8. The pixel circuit of claim 7, wherein the second node, the third node, and the fourth node are configured to receive the cathode voltage when the cathode voltage is applied to the first node.

9. The pixel circuit of claim 7, wherein:
a driving period of the pixel circuit includes a first phase in which the pixel circuit is configured to be initialized, a second phase in which the capacitor is configured to receive a threshold voltage of the driving element and the data voltage, and a third phase in which the light-emitting element is configured to emit light;
the first gate signal is configured to be at the gate-on voltage in the first phase and the second phase, and at the gate-off voltage in the third phase;
the second gate signal is configured to be at the gate-off voltage in the second phase, and at the gate-on voltage in the first and third phases;
the first, second, and fifth switch elements are configured to turn on in response to the gate-on voltage of the first gate signal and to turn off in response to the gate-off voltage of the first gate signal;
the third and fourth switch elements are configured to turn on in response to the gate-on voltage of the second gate signal and to turn off in response to the gate-off voltage of the second gate signal;
the one horizontal period includes periods of the first phase and the second phase; and
the data line is configured to be at the cathode voltage in the first phase and at the data voltage in the second phase.

10. The pixel circuit of claim 9, wherein:
the first switch element includes a gate electrode configured to receive the first gate signal, a first electrode connected to the data line, and a second electrode connected to the first node;
the second switch element includes a gate electrode configured to receive the first gate signal, a first electrode connected to the second node, and a second electrode connected to the third node;
the third switch element includes a gate electrode configured to receive the second gate signal, a first electrode connected to the first node, and a second electrode configured to receive the cathode voltage;
the fourth switch element includes a gate electrode configured to receive the second gate signal, a first electrode connected to the third node, and a second electrode connected to the fourth node; and
the fifth switch element includes a gate electrode configured to receive the first gate signal, a first electrode configured to receive the cathode voltage, and a second electrode connected to the fourth node.

11. The pixel circuit of claim 1, wherein:
the first voltage is a constant voltage, the first voltage being a reference voltage or a cathode voltage;
the second voltage is a data voltage corresponding to a pixel data; and
during one horizontal period, the compensation circuit is further configured to receive the first voltage through the data line and then to receive the second voltage through the data line.

12. The pixel circuit of claim 11, wherein:
the one horizontal period includes a horizontal blank period and a horizontal active period;
during the horizontal blank period, the compensation circuit is further configured to receive the first voltage, and not the second voltage, through the data line to initialize the pixel circuit; and
during the horizontal active period, the compensation circuit is further configured to receive the second voltage through the data line to write the pixel data to the pixel circuit.

13. The pixel circuit of claim 11, wherein:
the one horizontal period includes a horizontal blank period and a horizontal active period;
during the horizontal blank period, the first gate signal and the second gate signal are at a gate-on voltage; and
during the horizontal active period, the first gate signal is at the gate-on voltage, and the second gate signal is at a gate-off voltage.

14. A display device, comprising:
a display panel including a plurality of data lines, a plurality of gate lines, a plurality of power lines, and a plurality of pixel circuits, at least one of the pixel circuits being the pixel circuit of claim 1;
a data driver configured to output the first and second voltages;
a gate driver configured to supply at least one gate signal to the gate lines; and
a control circuit configured to control the data driver and the gate driver,
wherein the plurality of data lines include the data line, the plurality of gate lines include the first gate line and the second gate line, the at least one gate signal includes the first gate signal and the second gate signal, and the plurality of power lines include the first power line and the second power line.

15. The display device of claim 14, wherein:
the compensation circuit includes:
a capacitor coupled between a first node and a second node;
a first switch element connected between the data line and the first node and configured to turn on in response to a gate-on voltage of the first gate signal to electrically connect the data line to the first node;
a second switch element connected between the second node and a third node and configured to turn on in response to the gate-on voltage of the first gate signal to electrically connect the second node to the third node;
a third switch element connected to the first node and configured to turn on in response to a gate-on voltage of the second gate signal to apply the first voltage to the first node; and
a fifth switch element connected to a fourth node and configured to turn on in response to the gate-on voltage of the first gate signal to apply the first voltage to the fourth node;
the switch element includes a fourth switch element connected between the third node and the fourth node and configured to turn on in response to the gate-on voltage of the second gate signal to electrically connect the third node to the fourth node;
the driving element includes a gate electrode connected to the second node, a first electrode connected to the first power line configured to receive a pixel driving voltage, and a second electrode connected to the third node;
the light-emitting element includes an anode electrode connected to the fourth node, and a cathode electrode connected to the second power line configured to receive a cathode voltage; and
the first voltage includes a reference voltage or the cathode voltage, and the second voltage includes a data voltage of pixel data.

16. The display device of claim 14, wherein:
the control circuit is configured to transmit initialization data to the data driver as a digital signal; and
the data driver is configured to output the first voltage in response to the initialization data.

17. The display device of claim 16, wherein:
the control circuit is configured to update the initialization data every horizontal period; and
the first voltage has a voltage level corresponding to the initialization data.

18. The display device of claim 14, wherein the display panel includes:
a plurality of circuit parts in which the pixel circuits are disposed; and
a plurality of stretchable wires electrically connecting the plurality of circuit parts, and
wherein the stretchable wires include the data lines, the gate lines, and the power lines.

19. A display device of claim 14, further comprising:
a switch circuit configured to alternately select one of the first voltage and the second voltage and to supply the selected one of the first voltage and the second voltage to the data lines.

20. The display device of claim 19, wherein the switch circuit is further configured to select and supply the first voltage to the data line and then to select and supply to second voltage to the data line within one horizontal period.
